(19) United States
(12) Patent Application Publication
(10) Pub. No.: US 2015/0165381 A1
(43) Pub. Date: Jun. 18, 2015

(54) NANOFILTRATION PROCESS FOR IMPURITY REMOVAL

(71) Applicant: Chemetics Inc., Vancouver (CA)

(72) Inventors: Felix Mok, Vancouver (CA); Siamak Lashkari, Vancouver (CA); Ganapathy Ramasubbu, Delta (CA); Thomas Drackett, North Vancouver (CA); David Summers, Vancouver (CA)

(73) Assignee: Chemetics Inc., Vancouver (CA)

(21) Appl. No.: 14/413,497

(22) PCT Filed: Jul. 8, 2013
(86) PCT No.: PCT/CA2013/050523

§ 371 Date: Jan. 8, 2015

Related U.S. Application Data
(60) Provisional application No. 61/671,420, filed on Jul. 13, 2012.

(51) Int. Cl. B01D 61/02; C25B 15/08; B01D 69/12; B01D 69/02; B01D 61/04; B01D 61/08

(52) U.S. Cl. CPC B01D 61/027; B01D 61/04; B01D 61/08; B01D 69/12; B01D 69/02; C25B 15/08; B01D 2311/04; B01D 2311/103; B01D 2311/18; B01D 2325/30

(57) ABSTRACT

Nanofiltration membranes have been identified that can unexpectedly provide for competitive removal of silica and sulfate from brine in alkaline conditions. Such membranes are known as monolithic nanofiltration membranes and are particularly suitable for removing silica and sulfate impurities from a brine stream in a brine electrolysis plant.

### TECHNICAL FIELD

The present invention pertains to nanofiltration processes and systems for removing impurities from a brine stream used in industrial chemical processing. In particular, it pertains to nanofiltration processes for removing silica and sulfate impurities from brine streams used in industrial brine electrolysis.

### BACKGROUND

Pressure driven membrane separation processes are known wherein organic molecules or inorganic ionic solutes in aqueous solutions are concentrated or separated to various degrees by the application of a positive osmotic pressure to one side of a filtration membrane. Examples of such processes are reverse osmosis (RO), ultrafiltration (UF) and nanofiltration (NF). These pressure driven membrane processes employ a cross-flow mode of operation in which only a portion of a feed stream solution is collected as a permeate solution and the rest is collected as a pass solution. Thus, in a nanofiltration module, the exiting process stream which has not passed through the nanofiltration membrane is referred to as the “pass stream” and the exiting process stream which has passed through the membrane is referred to as the “permeate” stream.

NF membranes are structurally similar to RO membranes in that chemically, they typically are crosslinked aromatic polyamides, which are cast as a thin “skin layer” on top of a microporous polymer sheet support to form a composite membrane structure. The separation properties of the membrane are controlled by the pore size and electrical charge of the “skin layer”. Such a membrane structure is usually referred to as a thin film composite (TFC). However, unlike RO membranes, the NF membranes are characterized in having a larger pore size in its “skin layer” and a net negative electrical charge inside the individual pores. This negative charge is responsible for rejection of anionic species, according to the anion surface charge density. Accordingly, divalent anions, such as SO₄²⁻, are more strongly rejected than monovalent ones, such as Cl⁻. And therefore, nanofiltration can be particularly suitable for processes requiring separation of divalent anions from monovalent ones.

Commercial NF membranes are available from known suppliers of RO and other pressure driven membranes. The NF membranes are, typically, packaged as membrane modules. A so-called “spiral wound” module is most popular, but other membrane module configurations, such as tubular membranes enclosed in a shell or plate-and-frame type, are also known.

During the NF process, a minimum pressure equal to the osmotic pressure difference between the feed/pass liquor on one side and the permeate liquor on the other side of the membrane must be applied since osmotic pressure is a function of the ionic strengths of the two streams. In the case of separation of a multivalent solute, e.g. Na₂SO₄, from a monovalent one, e.g. NaCl, the osmotic pressure difference is moderated by the low NaCl rejection. Usually, a pressure in excess of the osmotic pressure difference is employed to achieve practical permeate flux.

Industrial brine electrolysis plants (e.g. chlor-alkali or chlorate plants) may advantageously use nanofiltration in certain of the processing steps, and particularly in the removal of sulfate from the brine streams employed. In these plants, various products are produced using brine as the starting material. For instance, sodium chlorate is generally prepared by the electrolysis of sodium chloride brine to produce chlorine, sodium hydroxide and hydrogen. The chlorine and sodium hydroxide are immediately reacted to form sodium hypochlorite, which is then converted to chlorate and chloride under controlled conditions of pH and temperature. Alternatively, chlorine and caustic soda are prepared by electrolysis of sodium chloride brine in an electrolytic cell or electrolyzer, which contains a membrane to prevent chlorine and caustic soda reacting.

However, the sodium chloride salt used to prepare the brine for electrolysis generally contains impurities which, depending on the nature of the impurity and production techniques employed, can give rise to plant operational problems familiar to those skilled in the art. While the means of controlling these impurities are varied and include, purging them out of the system into alternative processes or to the drain, precipitation by conversion to insoluble salts, crystallization or ion exchange treatment, the control of anionic impurities presents more complex problems than that of cationic impurities.

Sulfate ion is a common impurity in commercial salt and being an anion is a more complex impurity to deal with. When such salt is used directly, or in the form of a brine solution, and specific steps are not taken to remove the sulfate, the sulfate enters the electrolytic system. Sulfate ion maintains its identity under the conditions in the electrolytic system and, thus, accumulates and progressively increases in concentration in the system unless removed in some manner In chlorate plants producing a liquor product, the sulfate ion will leave with the product liquor. In plants producing only crystalline chlorate, the sulfate remains in the mother liquor after the crystallization of the chlorate, and is recycled to the cells. Over time, the concentration of sulfate ion will increase and adversely affect electrolysis and cause operational problems due to localized precipitation in the electrolytic cells. Within the chlor-alkali circuit, the sodium sulfate will concentrate and adversely affect the membrane, which divides the anolyte (brine) from the catholyte (caustic soda). It is industrially desirable however that sodium sulfate levels in concentrated brine, e.g., 300 g/L NaCl, be reduced to at least 20 g/L in chlorate production and about 10 g/L in chlor-alkali production.

Some years ago, it was found that NF membranes showed unexpected ion membrane selectivity at relatively high salt concentrations and this offered attractive application in the treatment of brine electrolysis liquors having unacceptable sodium sulfate levels in recycle systems. U.S. Pat. No. 5,587,083 and U.S. Pat. No. 5,858,240 disclosed such use of nanofiltration systems for purposes of sulfate removal from spent electrolysis brine. When using these nanofiltration processes, because there was no buildup in concentration of sodium chloride in the pass liquor stream over its original level in the feed stream, it was possible to increase the content of sodium sulfate in the pass liquor to a higher level than would have been possible if the NaCl level of the pass liquor had increased. It was now possible to realize a desirable high % recovery, and, in the case of electrolysis brine, to minimize the volume of brine purge, and/or the size of a reactor and the amount of chemicals for an optional, subsequent sulfate precipitation step.

Silica is another impurity present in varying amounts in commercial sources of brine salt. Like sulfate ion, silica species also enter the brine streams prepared for use in electrolysis plants unless steps are taken to completely remove it. Suspended and soluble silica in the brine stream leads to formation of deposits and precipitation of insoluble silicates which adversely affects cell performance and causes premature wear on anode coatings and fouling of ion exchange membranes. Thus, the concentration of silica in these brine streams is also desirably kept below certain maximum amounts.

Primary treatment methods may be employed to remove most of the silica when first preparing brine solutions from less pure sources such as solar or rock salt. However, primary treatment can involve purging amounts of treated brine which is undesirable for environmental and economic reasons. Conventional primary treatment may be eliminated when using purer sources of salt, such as evaporated salt. Regardless, some silica impurity typically remains in the prepared brine streams and, like sulfate ion, it accumulates over time as a consequence of recycling and thus must eventually be removed.

Silica species can be removed from the recirculating brine stream in various ways. Periodic purging may be employed but again this is undesirable for environmental and economic reasons. Chemical precipitation methods may instead be used. For instance, silica impurity can be removed by adding a soluble magnesium compound to the brine stream and appropriately adjusting the pH thereby precipitating out silicates as compounds of magnesium. A preferred method however may be to remove silica species concurrently with sulfate ion via a nanofiltration process.

U.S. Pat. No. 5,587,083 discloses a suitable NF process for removing both sulfate (e.g. Na₂SO₄) and silica (e.g. SiO₂) impurity in chlor-alkali and chlorate electrolysis applications. In the process, silica impurity is preferably converted to divalent SiO₃²⁻ by adjusting the pH of the brine stream to a suitable alkaline condition (e.g. pH ˜11). Unfortunately, prior art NF membranes have not been entirely suitable for this purpose commercially.

A suitable commercial NF membrane should exhibit good rejection characteristics for both SiO₃²⁻ and SO₄²⁻, good throughput or permeate flux, and also longevity under the necessary alkaline conditions. Certain prior art membranes may have suitable rejection and flux characteristics but are unstable in alkaline conditions and do not survive long enough to be useful. Other prior art membranes that were designed for alkaline conditions can tolerate the required pH levels for commercially viable time periods, but these suffer from inferior rejection and/or flux characteristics. To date, commercially viable membranes have not been identified for this purpose.

New types of NF membranes continue to be developed for a diversity of industrial applications. For instance, new solvent and acid stable NF membranes were disclosed in WO2010/082194 for separating metal ions from liquid process streams. These membranes include a non-cross-linked base polymer having reactive pendant moieties, in which the base polymer is modified by forming a cross-linked skin onto a surface thereof. The skin is formed by a cross-linking reaction of reactive pendant moieties on the surface with an oligomer or another polymer.

There still remains a need however to develop and identify NF membranes suitable for the effective removal of these and other impurities in brine streams in brine electrolysis processing. The present invention addresses this need and provides other benefits as disclosed below.

### SUMMARY

Surprisingly, certain NF membranes including some designed for acid and solvent applications have demonstrated unexpectedly superior rejection characteristics in alkaline conditions for rejection of silica species in brine and particularly excellent characteristics for rejection of sulfate in brine. Such membranes provide a satisfactory level for permeate flux and also show satisfactory stability in certain alkaline conditions.

Specifically, a nanofiltration process and system are provided for removing silica and sulfate impurities from a brine stream comprising an aqueous solution of NaCl and silica and sulfate impurities. The method comprises employing a suitable nanofiltration membrane for use in a nanofiltration module in the nanofiltration system, adjusting the pH of the brine stream to be greater than 9, and then subjecting the brine stream to the nanofiltration system.

A suitable nanofiltration membrane is a monolithic nanofiltration membrane which comprises a polymeric semipermeable membrane and a nanofiltration layer. The polymeric semipermeable membrane comprises a non-cross-linked base polymer and a cross-linked skin on a surface of the base polymer. The nanofiltration layer is covalently bonded to the cross-linked skin in the polymeric semipermeable membrane. In some embodiments, the non-cross-linked base polymer can have reactant pendant moieties and the skin can be a cross-linked reaction product of the reactant pendant moieties and an oligomer or another polymer.

In particular, the pH of the brine stream can be adjusted to between about 10 and about 12, or even narrower to between about 10.5 and about 11. These can be preferred ranges for removal of silica and sulfate impurities. The invention can be effective for brine streams comprising up to about 50 mg/L of SiO₂ and up to about 100 g/L of NaSO₄. In particular, embodiments of the invention have been demonstrated to be effective for brine streams comprising up to about 20 mg/L of SiO₂ and up to about 10 g/L of NaSO₄. Further, the method can be employed to remove other impurities from the brine stream in addition to silica and sulfate impurities. The temperature of the brine stream can be less than or about 80° C. In exemplary embodiments of the method, the temperature of the brine stream was less than or about 50° C.

A related nanofiltration system comprises a nanofiltration module comprising a monolithic nanofiltration membrane for rejecting sulfate and which is also suitable for rejecting silica under alkaline conditions. The monolithic nanofiltration membrane can be an acid/solvent stable nanofiltration membrane. The module additionally comprises an inlet for a feed stream, an outlet for a permeate stream which has permeated through the membrane, and an outlet for a pass stream which has not permeated through the membrane. The nanofiltration system additionally comprises a subsystem upstream of the feed stream inlet for adjusting pH of the brine stream. Further, the nanofiltration system may be a multi-stage system comprising at least a first nanofiltration module and a second nanofiltration module in series. A greater number of nanofiltration modules in series or parallel may be contemplated depending on the specific circumstances.

The nanofiltration system may be particularly employed to remove impurities from the spent brine stream or product liquor coming from electrolyzers used in industrial brine electrolysis chemical processing. Thus, a related brine electrolysis system, such as a chlor-alkali or chlorate plant, comprises a brine electrolyzer comprising an inlet for supply of fresh brine for electrolysis and an outlet for spent brine following electrolysis, a recirculation line fluidly connecting the spent brine outlet of the electrolyzer to the fresh brine inlet of the electrolyzer inlet, and the aforementioned nanofiltration system located in the recirculation line to remove silica and sulfate impurities from the brine.

### BRIEF DESCRIPTION OF THE DRAWINGS

FIG. 1 shows a simplified schematic of an industrial chlor-alkali plant comprising an electrolyzer and a nanofiltration impurity removal system.

FIG. 2 plots the results for % silica rejection and % sulfate rejection versus pH of the brine stream for the alkaline stable NF membrane tested in the Examples.

FIG. 3 plots the results for % silica rejection and % sulfate rejection versus pH of the brine stream for the acid/solvent stable NF membrane tested in the Examples.

FIG. 4 shows a simplified schematic of the multi-stage impurity removal system in the Examples comprising multiple nanofiltration membrane modules in a series and parallel arrangement.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

In a numerical context, the word “about” is to be construed as meaning plus or minus 10%.

Herein, a monolithic nanofiltration membrane refers to a nanofiltration membrane as generally described in WO2010/082194 in which the nanofiltration layer is covalently bound to an underlying ultrafiltration support, which in turn is optionally covalently bound to its own support (e.g. a non-woven or woven support). Such membranes comprise a polymeric semipermeable membrane comprising a non-cross-linked base polymer in which the base polymer is modified by forming a cross-linked skin onto a surface thereof. The base polymer can have reactive pendant moieties and the skin can be formed by a cross-linking reaction of reactive pendant moieties on the surface with an oligomer or another polymer. The nanofiltration layer is covalently bonded to the cross-linked skin of the polymeric semipermeable membrane.

An acid/solvent stable monolithic nanofiltration membrane is a nanofiltration membrane as generally described in WO2010/087194 but designed for use in both acidic and solvent media (including for instance 20% H₂SO₄, acetonitrile, ethyl acetate, 2-propanol, tetrahydrofuran, toluene, N-methyl pyrrolidone, methanol, ethanol, hexane, acetone, dimethylformamide, and methylene chloride). Such an acid/solvent stable NF membrane is thus not designed for use in basic media. An NF membrane generally described in WO2010/082194 but designed for use in alkaline media is referred to herein as an alkaline stable membrane.

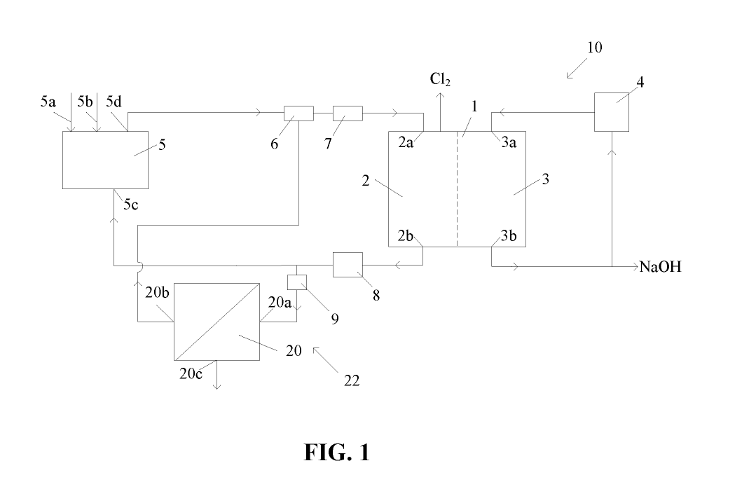

A simplified schematic for a chlor-alkali plant 10 comprising a nanofiltration system of the invention is shown in FIG. 1. In the process depicted here, NaCl based brine undergoes electrolysis in electrolyzer 1 to produce primary products chlorine gas at anode 2 and NaOH and hydrogen gas at cathode 3. Other products can then be obtained as a result of an additional series of reactions between these primary products. For instance, sodium chlorate product, NaClO₃, can be obtained by allowing the chlorine and NaOH caustic to intermix under appropriate controlled conditions (not shown). In plant 10, catholyte is provided to cathode inlet 3a of electrolyzer 1 from catholyte tank 4. Spent catholyte is withdrawn from cathode outlet 35 and one portion is recycled back to catholyte tank 4 while another portion is removed to obtain a supply of product (e.g. NaOH caustic product). Anolyte brine is prepared in saturator 5 and then provided from saturator outlet 5d to anode inlet 2a of electrolyzer 1. Spent anolyte is withdrawn from anode outlet 2b and is recycled back to saturator 5 at recycle inlet 5c for reuse. The appropriate concentration of NaCl brine for the electrolysis process is maintained by adding the right amounts of process solid crystalline salt and process water at saturator inlets 5a and 5b respectively.

Chlor-alkali plants typically comprise other subsystems, such as for purification or control purposes. FIG. 1 shows some common subsystems in such plants. Here, chlor-alkali plant 10 comprises primary treatment subsystem 6 and secondary treatment subsystem 7 which are used to remove impurities from the anolyte brine prepared in saturator 5. In primary treatment subsystem 6, caustic and soda ash are typically added to precipitate out Ca and Mg impurities. In secondary treatment subsystem 7, other trace metal impurities are removed by ion exchange techniques. Also shown in FIG. 1 is dechlorination subsystem 8 for removing chlorine from the brine stream following electrolysis. (Note that other components and/or subsystems, such as pumps, heat exchangers, control subsystems, are typically employed in an industrial chlor-alkali plant like that shown in FIG. 1, but these have been omitted for simplicity.)

As mentioned previously, sodium sulfate and silica impurities undesirably accumulate in the recycling anolyte unless it is continually removed. In the chlor-alkali plant of FIG. 1, nanofiltration system 22 is provided for that purpose as a branch loop in the recycling anolyte line between anode outlet 2b and saturator recycle inlet 5c. Sulfate and silica are continually removed from the circulating anolyte stream by directing a portion of the spent anolyte to feed 20a of nanofiltration module 20. Purified brine permeate is returned to the circulating anolyte from permeate outlet 20b and a reject stream concentrated in sulfate and silica species is removed from circulation at pass outlet 20c. Nanofiltration system 22 also comprises subsystem 9 which is located upstream of the feed 20a of NF module 20 and is provided for adjusting pH of the brine stream (e.g. via addition of NaOH). The brine stream is adjusted to an alkalinity above a pH of 9, and preferably to a pH between 10 and 12 or even narrower to a pH between 10.5 and 11, in order to provide for effective removal of both silica and sulfate species. The pH of the brine permeate from permeate outlet 20b may optionally be adjusted again, e.g. via addition of HCl, using another subsystem (not shown in FIG. 1) to compensate for the increase in alkalinity resulting from the pH adjustment from subsystem 9. And then, the pH adjusted brine permeate can be directed to saturator 5 along with the rest of the spent anolyte from electrolyzer 1. Preferably however, the brine permeate from nanofiltration module 20 bypasses saturator 5 and is directed instead to primary treatment subsystem 6. Primary treatment generally involves the addition of caustic, thereby increasing alkalinity of the brine stream at this stage of the process. By directing the brine permeate to primary treatment subsystem 6 as shown in FIG. 1, no pH adjustment of the alkaline brine permeate stream may be required and, in addition, the amount of caustic employed in primary treatment may be somewhat reduced.

In an exemplary embodiment, NF module 20 employs an acid/solvent stable monolithic nanofiltration membrane of the kind generally described in WO2010/082194. As demonstrated in the following Examples, such membranes can surprisingly provide for superior rejection of both sulfate and silica species with a satisfactory permeate flux in alkaline conditions even though not designed or intended for use in alkaline conditions. Importantly, the membranes also enjoy satisfactory stability in such alkaline conditions. Use of such NF membranes allows for the commercially viable, concurrent removal of sulfate and silica impurities from the recycling brine stream.

As per WO2010/082194, exemplary acid/solvent stable monolithic nanofiltration membranes can be prepared by starting with a commercial PAN or PVDF microfiltration membrane and cross-linking the membrane by soaking in 4% polyethylenimine solution for 17 hours at 90° C. The product is then further cross-linked by reacting at 10 bar pressure for 30 minutes with an aqueous solution of branched PEI and a 0.075% aqueous solution of a dichlorotriazine/anilinesulfonic acid condensate. The branched PEI will add cross-linking and the condensation product will add sulfonic acid moieties. The excess solution is drained away and the membrane product is heat cured at 90° C. for 30 minutes. The membrane product is then placed in a 20% aqueous ethanol solution containing 0.1% of the preceding condensate product and heated at 60° C. for 1 hour to complete the cross-linking step. Finally, the chloro-groups of the membrane product are hydrolyzed by reacting at 90° C. in 20% sulfuric acid, which replaces the Cl groups with SO₃H groups.

In alternative embodiments, NF module 20 may employ other suitable monolithic nanofiltration membranes. For instance, base stable monolithic nanofiltration membranes are also suitable. Such membranes may be made in a like manner to the preceding acid/solvent stable membranes except that a microfiltration membrane made of a different starting material is employed (e.g. PES) and the final hydrolyzing/acidifying step is omitted.

While the preceding is primarily directed at the removal of sulfate and silica impurities, the system of the invention may also advantageously remove other impurity species in addition to or instead of these. For instance, in a pH range from about 10.5 to 11, over half of any Na₂CO₃ present would exist in dissolved form as CO₃²⁻ in the electrolyzer feed brine. Advantageously, this carbonate anion could also be removed by the same NF system to improve the efficacy of the downstream liquefaction operation.

The following Examples have been included to illustrate certain aspects of the invention but should not be construed as limiting in any way. Those skilled in the art can be expected to appreciate how to modify the nanofiltration system and process to suit a given industrial application in the removal of silica and sulfate.

### EXAMPLES

Several commercially available nanofiltration membranes were obtained and evaluated as possible candidates for silica and sulfate removal in a chlor-alkali electrolysis system like that shown in FIG. 1.

The NF membranes obtained were:
SelRO® MPS-34—pH Stable Membrane from Koch Membrane Systems, a membrane with an allowable pH range for continuous operation of from 0 to 14.
Nadir® NP030—chemical resistant membrane from Microdyn-Nadir; a polyethersulphone (PES) based NF membrane with allowable pH for operating of from 0 to 14.
Desal® DK Series membrane from GE Osmonics; a polyamide-based NF membrane rated for continuous use in a pH range from 3 to 9.
Nano-Pro® B-4022 Base Stable Membrane from Bio Pure Technology; a monolithic nanofiltration membrane designed for operation in alkaline applications with an allowable pH for continuous operation of from 1 to 14.
Nano-Pro® AS-3012 Acid/Solvent Stable Membrane from Advanced Membrane Technologies (a successor company to Bio Pure Technology); a monolithic nanofiltration membrane designed for operation in acid/solvent applications with an allowable pH for continuous operation of from 0 to 12.

The silica and sulfate rejection (% pass) characteristics were obtained using laboratory size samples for each of the above in brine solution containing 200 g/L NaCl, 9.0 g/L Na₂SO₄, and 18.2 mg/L SiO₂, over a range of pH levels between 7 and 11, at a temperature of 50° C., and at applied pressure of 600 psig. The flux of the permeate through the membrane was also measured and recorded.

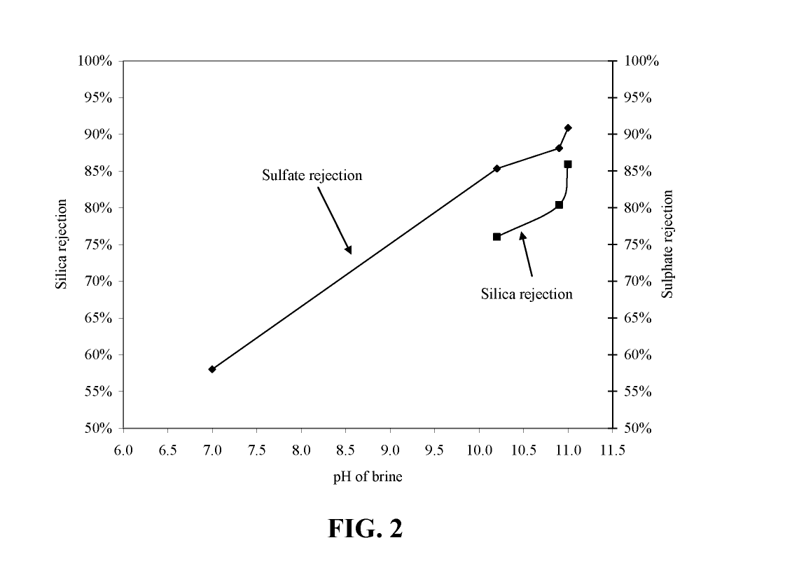

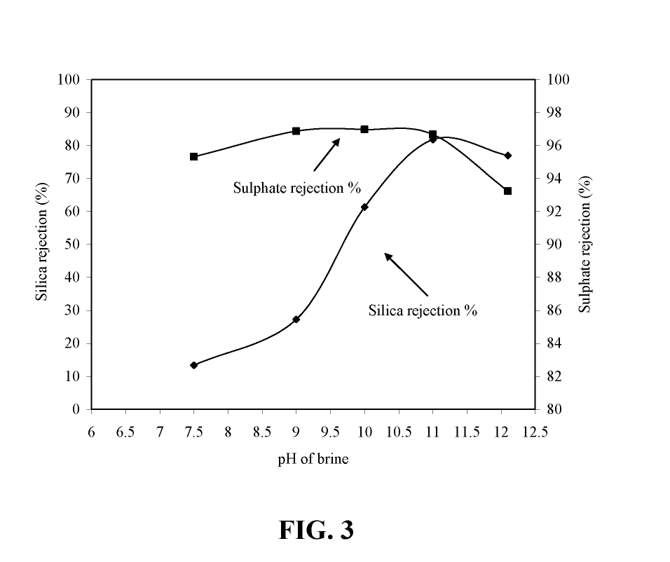

FIG. 2 plots the results for % silica rejection and % sulfate rejection versus pH of the brine stream for the Alkaline Stable Nano-Pro® B-4022 membrane while FIG. 3 plots those results for the Acid/Solvent Stable Nano-Pro® AS-3012 membrane. Table 1 below tabulates the silica and sulfate rejection values for each membrane at pH levels of 7 and 11 (note: the value at pH 7 was not determined for the Alkaline Stable membrane).

TABLE 1
Membrane characteristics at different pH

| | | | | Permeate flux |
|---|---|---|---|---|
| | | Silica | Sulfate | (mL/min-m²-psi) |
| | | Rejection | Rejection | (at 50° C. & |
| Membrane Type | pH | (%) | (%) | 600 psig) |
| SelRO ® MPS-34 | 7.0 | 8.0 | 65.0 | 2.1 |
| | 11.0 | 60.0 | 65.0 | 3.3 |
| Nadir ® NP030 | 7.0 | 19.7 | 45.6 | 2.75 |
| | 11.0 | 43.0 | 44.2 | 2.5 |
| Desal ® DK | 7.0 | 9.0 | >99.0 | 2.4 |
| | 11.0 | >99.0 | >99.0 | 2.5 |
| Nano-Pro ® B-4022 | 11.0 | 80.0 | 88.0 | 0.4 |
| (Alkaline Stable) | | | | |
| Nano-Pro ® AS-3012 | 7.0 | 12.0 | 95.0 | 1.2 |
| (Acid/Solvent Stable) | 11.0 | 81.0 | 96.0 | 1.0 |

The SelRO® MPS-34 NF membrane is expected to tolerate alkaline conditions but shows inferior results for both silica and sulfate rejection even at pH 11. Such characteristics would generally be considered inadequate for commercial use in a chlor-alkali electrolysis system. The Nadir® NP030 membrane would similarly be considered inadequate for such commercial use.

The Desal® DK series NF membrane showed impressive rejection characteristics for both impurity species at pH 11. However, this type of membrane undergoes alkaline hydrolysis when exposed to pH levels greater than or about 10. While the testing results are impressive, the membrane deteriorates too quickly at this pH as illustrated in the following stability tests.

The Nano-Pro® B-4022 membrane exhibited better rejection efficiencies for silica and sulfate than the alkaline stable SelRO® MPS-34 membrane at pH 11. However, the permeate flux was almost an order of magnitude lower under the same conditions. Correspondingly more membrane would thus be required to treat a given quantity of brine.

The Nano-Pro® AS-3012 membrane, which was intended for use in acid/solvent applications and not alkaline conditions, unexpectedly shows adequate rejection of silica and excellent rejection of sulfate at pH 11. The sulfate rejection for this membrane was substantially better than that for the alkaline stable Nano-Pro® B-4022 membrane. Further, the permeate flux under these conditions is acceptable for commercial consideration.

Testing then was performed to determine the ability of the latter three membrane materials to withstand prolonged exposure to caustic conditions. Sample coupons of each were soaked for extended periods of time in alkaline brine solution containing excess caustic (NaOH) at 50° C. and at a pH of 10.5, 11, or 12 as indicated. Performance characteristics were obtained as above on certain sample coupons after 14 days, 30 days, or longer as indicated. Table 2 below tabulates the silica and sulfate rejection and the permeate flux characteristics obtained.

TABLE 2
Membrane characteristics after prolonged exposure to
alkaline conditions

| | | | | | Permeate flux |
|---|---|---|---|---|---|
| | | Soak | Silica | Sulfate | (mL/min-m²-psi) |
| Membrane | Soak | time | Rejection | Rejection | (at 50° C. & |
| Type | pH | (days) | (%) | (%) | 600 psig) |
| Desal ® DK | 11 | 14 | 47.9 | 94.9 | 2.6 |
| | 12 | 14 | 46.0 | 78.7 | 2.86 |
| | 11 | 30 | 0.0 | 57.8 | 4.97 |
| | 12 | 30 | 0.0 | 7.8 | 8.25 |
| Nano-Pro ® | 12 | 30 | 73.6 | 88.0 | 1.4 |
| B-4022 | 12 | 90 | 65.1 | 88.5 | 0.774 |
| (Alkaline | 12 | 180 | 64.2 | 91.2 | 1.2 |
| Stable) | 12 | 360 | 71.0 | 81.0 | 0.29 |
| Nano-Pro ® | 10.5 | 30 | 77.7 | 90.4 | 0.836 |
| AS-3012 | 10.5 | 60 | 61 | 91.7 | 1.18 |
| (Acid/ | 10.5 | 90 | 62.4 | 92.1 | 1.37 |
| Solvent | 10.5 | 180 | 57.9 | 81.5 | 1.55 |
| Stable) | 10.5 | 270 | NA | 92.7 | 1.37 |
| | 10.5 | 360 | 59 | 81 | 1.58 |
| | 11 | 30 | 71.4 | 96.7 | 1.25 |
| | 11 | 60 | 55.8 | 88.7 | 0.839 |
| | 11 | 90 | 25 | 47.4 | 0.522 |
| | 11 | 105 | 24 | 34.6 | 0.525 |
| | 12 | 14 | 72.5 | 96.3 | 0.965 |
| | 12 | 30 | 31.9 | 61.4 | 0.987 |
| | 12 | 60 | 0 | 0 | NA |

The Desal® DK membrane deteriorated substantially over time at both pH 11 and 12 as evidenced by large drops in both the silica and sulfate rejection % and by a large increase in the permeate flux. After 30 days at pH 11 or 12, this membrane showed no ability to reject silica. And at pH 12, the sulfate rejection for this membrane dropped an order of magnitude. This membrane type is obviously unsuitable for use under these alkaline conditions.

After 30 days at pH 12, the Nano-Pro® B-4022 membrane showed a significant increase in permeate flux and a slight reduction in silica rejection capability. Such initial changes may result from an initial progressive wetting of the membrane and/or other conditioning phenomena common to such membranes, or from large variability of the membrane structure. The membrane retained desirable rejection characteristics for both silica and sulfate over a very long time period of 360 days.

The Nano-Pro® AS-3012 membrane showed a definite deterioration in rejection characteristics, and particularly in silica rejection, after prolonged exposure to caustic solution at pH 12. After 30 days, the colour of the membrane changed from a creamy light beige to an intense dark orange brown. After 60 days, the membrane showed no ability to reject either silica or sulfate. It does not appear that this membrane is stable up to pH 12 as suggested. However, at pH 11, the results were significantly better. After 30 days at pH 11, the sulfate rejection and permeate flux characteristics had changed only slightly. A slight reduction in silica rejection was observed. After 105 days though, both the silica and sulfate rejection characteristics had suffered significantly. At pH 10.5, the membrane retained adequate rejection characteristics for both silica and sulfate over a very long time period of 360 days.

As is evident from these Examples, certain monolithic nanofiltration membranes can provide superior rejection for both silica and sulfate impurities at an acceptable flux. Further, with appropriate pH control, these membranes are also expected not to deteriorate significantly and thus should have acceptable lifetimes in operation.

Calculations were then performed on an exemplary nanofiltration system of the invention to illustrate the potential results when used in a commercial scale chlor-alkali electrolysis plant.

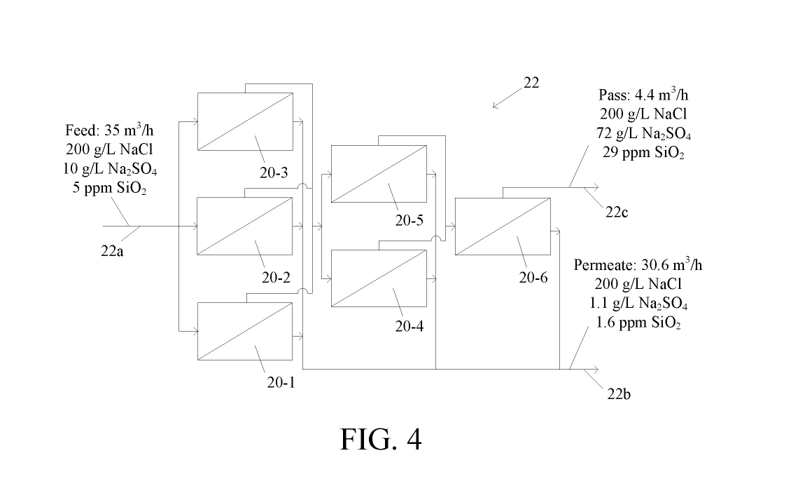

FIG. 4 shows a schematic of a multi-stage nanofiltration system 22 for possible use in purifying spent anolyte brine in a commercial scale chlor-alkali plant like that depicted in FIG. 1. A configuration comprising six nanofiltration modules, based on membranes with similar properties to the aforementioned Nano-Pro® AS-3012 membrane and in a series-parallel arrangement, was optionally selected in order to achieve high recovery, i.e. 90%. (However, other configurations could be selected to achieve lower costs or system simplification.) Here, nanofiltration system 22 comprises six nanofiltration modules 20-1, 20-2, 20-3, 20-4, 20-5, and 20-6. To avoid clutter in FIG. 4, the feeds, permeate outlets, and pass outlets of these modules have not been numbered. However, the feed for each module appears on the left side of each module. The permeate outlet for each module appears on the right side of each module. And the pass outlet for each module appears on the top of the module. Nanofiltration system 22 is supplied with spent brine at feed 22a which is then split into three streams and directed to the feeds of three initial nanofiltration modules 20-1, 20-2, 20-3 arranged in parallel. The pass outlets of these parallel modules are then combined and directed to the feeds of another pair of like nanofiltration modules 20-4 and 20-5, also arranged in parallel. In turn, the pass outlets of this pair of modules are combined and directed to the feed of final nanofiltration module 20-6. Permeate from the permeate outlets of each module are combined and exit at permeate outlet 22b of the system. And the pass streams from the pass outlets of each module are combined and exit at pass outlet 22c of the system.

In this calculated example, it was assumed that the feed stream was supplied at 35 m³/h and comprised 200 g/L NaCl, 10 g/L Na₂SO₄, and 5 ppm SiO₂. The expected characteristics of system permeate stream 22b using the selected system configuration of FIG. 4 would then be 30.6 m³/h with 200 g/L NaCl, 1.1 g/L Na₂SO₄, and 1.6 ppm SiO₂. The expected characteristics of system pass stream 22c would be 4.4 m³/h with 200 g/L NaCl, 72 g/L Na₂SO₄, and 29 ppm SiO₂.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method for removing silica and sulfate impurities from a brine stream using a nanofiltration system, the brine stream comprising an aqueous solution of NaCl, silica impurity, and sulfate impurity, the method comprising:
employing a monolithic nanofiltration membrane in the nanofiltration system, wherein:
the monolithic nanofiltration membrane comprises a polymeric semipermeable membrane and a nanofiltration layer;
the polymeric semipermeable membrane comprises a non-cross-linked base polymer and a cross-linked skin on a surface of the base polymer; and
the nanofiltration layer is covalently bonded to the cross-linked skin in the polymeric semipermeable membrane;
adjusting the pH of the brine stream to be greater than 9; and
subjecting the brine stream to the nanofiltration system.

2. The method of claim 1 comprising adjusting the pH of the brine stream to between about 10 and about 12.

3. The method of claim 2 comprising adjusting the pH of the brine stream to between about 10.5 and about 11.

4. The method of claim 1 wherein the brine stream comprises up to about 50 mg/L of SiO₂.

5. The method of claim 4 wherein the brine stream comprises up to about 20 mg/L of SiO₂.

6. The method of claim 1 wherein the brine stream comprises up to about 100 g/L of NaSO₄.

7. The method of claim 6 wherein the brine stream comprises up to about 10 g/L of NaSO₄.

8. The method of claim 1 comprising removing other impurities from the brine stream in addition to silica and sulfate impurities.

9. The method of claim 1 wherein the temperature of the brine stream is less than or about 80° C.

10. The method of claim 9 wherein the temperature of the brine stream is less than or about 50° C.

11. The method of claim 1 comprising employing an acid/solvent stable monolithic nanofiltration membrane in the nanofiltration system.

12. A nanofiltration system for removing silica and sulfate impurities from an alkaline brine stream comprising an aqueous solution of NaCl, silica impurity, and sulfate impurity, the system comprising:
a nanofiltration module comprising:
a monolithic nanofiltration membrane for rejecting silica and sulfate, wherein the monolithic nanofiltration membrane comprises a polymeric semipermeable membrane and a nanofiltration layer, the polymeric semipermeable membrane comprises a non-cross-linked base polymer and a cross-linked skin on a surface of the base polymer, and the nanofiltration layer is covalently bonded to the cross-linked skin in the polymeric semipermeable membrane;
an inlet for a feed stream;
an outlet for a permeate stream which has permeated through the membrane; and
an outlet for a pass stream which has not permeated through the membrane; and
a subsystem upstream of the feed stream inlet for adjusting pH of the brine stream to be greater than 9.

13. The nanofiltration system of claim 12 wherein the subsystem is for adjusting the pH of the brine stream to between about 10 and about 12.

14. The nanofiltration system of claim 13 wherein the subsystem is for adjusting the pH of the brine stream to between about 10.5 and about 11.

15. The nanofiltration system of claim 12 wherein the brine stream comprises up to about 50 mg/L of SiO₂.

16. The nanofiltration system of claim 15 wherein the brine stream comprises up to about 20 mg/L of SiO₂.

17. The nanofiltration system of claim 12 wherein the brine stream comprises up to about 100 g/L of NaSO₄.

18. The nanofiltration system of claim 17 wherein the brine stream comprises up to about 10 g/L of NaSO₄.

19. The nanofiltration system of claim 12 wherein the brine stream comprises other impurities in addition to silica and sulfate impurities.

20. The nanofiltration system of claim 12 comprising a subsystem for adjusting the temperature of the brine stream to be less than or about 80° C.

21. The nanofiltration system of claim 20 comprising a subsystem for adjusting the temperature of the brine stream to be less than or about 50° C.

22. The nanofiltration system of claim 12 wherein the monolithic nanofiltration membrane is an acid/solvent stable monolithic nanofiltration membrane.

23. A brine electrolysis system comprising:
a brine electrolyzer comprising an inlet for supply of fresh brine for electrolysis and an outlet for spent brine following electrolysis;
a recirculation line fluidly connecting the spent brine outlet of the electrolyzer to the fresh brine inlet of the electrolyzer inlet; and
the nanofiltration system of claim 12 located in the recirculation line to remove silica and sulfate impurities from the brine.
